(19) United States
(12) Patent Application Publication
(10) Pub. No.: US 2021/0312464 A1
(43) Pub. Date: Oct. 7, 2021

(54) SPEECH RECOGNITION ORDERING SYSTEM AND RELATED METHODS

(71) Applicant: JETSON AI INC., New York, NY (US)

(72) Inventors: Peter Peng, Orlando, FL (US); Yang Li, Jersey City, NJ (US); Vidhiben Bharatkumar Sadrani, Jersey City, NJ (US); Christopher Fine, Ridgewood, NJ (US); Rojer Jie Luo, Los Angeles, CA (US)

(21) Appl. No.: 16/968,929

(22) PCT Filed: Feb. 14, 2019
(86) PCT No.: PCT/US2019/017937

§ 371 Date: Feb. 17, 2021

Related U.S. Application Data
(60) Provisional application No. 62/630,457, filed on Feb. 14, 2018.
(60) Provisional application No. 62/747,829, filed on Oct. 19, 2018.

(51) Int. Cl. G06Q 20/40; G06Q 20/36; G06Q 30/06; G10L 15/22; G10L 15/26; G10L 15/30

(52) U.S. Cl. CPC G06Q 20/40145; G06Q 20/3674; G06Q 30/0641; G10L 2015/228; G10L 15/26; G10L 15/30; G10L 15/22

(57) ABSTRACT

A method of speech recognition ordering may include generating a voice database having a biometric characteristic for each of the different users, and a voice profile for each of the different users. The method may include providing an ordering user interface, receiving speech input including an order from a given user, and determining a given biometric characteristic for the given user. The method may have identifying the given user from the different users by comparing the given biometric characteristic with the biometric characteristic for each of the different users, and performing speech recognition on the speech input using an order database including potential order permutations, the speech recognition being based upon a given voice profile of the given user.

### RELATED APPLICATION

This application is based upon prior filed copending application Ser. No. 62/747,829 filed Oct. 19, 2018 and application Ser. No. 62/630,457 filed Feb. 14, 2018, the entire subject matter of these applications is incorporated herein by reference in its entirety.

### TECHNICAL FIELD

The present disclosure relates to the field of input-output data systems, and, more particularly, to a speech recognition system and related methods.

### BACKGROUND

Speech recognition is the inter-disciplinary sub-field of computational linguistics that develops methodologies and technologies that enable the recognition and translation of spoken language into text by computers. It is also known as “automatic speech recognition” (ASR), “computer speech recognition”, or just “speech-to-text” (STT).

Early approaches to speech recognition relied heavily on enrollment or training efforts. Although this improved speech recognition accuracy, this made speech input quite limited and cumbersome to use. Speaker independent, i.e. no training, speech recognition systems alleviated some of this concern, but were still limited.

Speech recognition was deployed on mobile wireless communications device, but this application was limited due to the limited computational resources available on the mobile device. This limitation was ever present until the wide deployment of high bandwidth fourth generation wireless networks. With the increased bandwidth and improved reliability of these new networks, it was now practical to quickly upload high quality recorded speech to a main server with sufficient computational resources to perform speech recognition.

Indeed, with millions of users uploading their speech to a central server, machine learning approaches were now viable. This big data enhancement of speech recognition greatly improved the accuracy of prior approaches. Another advantage to cloud based speech recognition systems is that they can be deployed in third party software applications by providing an application programming interface (API).

### SUMMARY

Generally, a speech recognition ordering system may include a housing, a display carried by the housing, an audio input device carried by the housing, a memory carried by the housing, and a processor carried by the housing and coupled to the display, audio input device, and memory. The processor may be configured to generate a voice database comprising at least one biometric characteristic for each of a plurality of different users, and a voice profile for each of the plurality of different users, provide an ordering graphical user interface (GUI) on the display, and receive speech input from the audio input device, the speech input comprising at least one order from a given user. The processor may be configured to determine at least one given biometric characteristic for the given user and based upon the speech input, identify the given user from the plurality of different users by comparing the at least one given biometric characteristic with the at least one biometric characteristic for each of the plurality of different users, and perform speech recognition on the speech input using an order database comprising a plurality of potential order permutations, the speech recognition being based upon a given voice profile of the given user.

In particular, the order database may include a plurality of order preferences for each of the plurality of different users, and the processor may be configured to selectively process the at least one order based upon respective order preferences of the given user. The processor may be configured to provide additional ordering prompts on the GUI when the at least one order comprises an ambiguous order. The processor may be configured to identify the given user from the plurality of different users by verifying an identification string in the speech input.

Also, processor may be configured to perform the speech recognition by at least transmitting the speech input to at least one cloud voice recognition service, and receiving a text speech output associated with the speech input from the at least one cloud voice recognition service. The processor may be configured to perform the speech recognition by at least load balancing the transmitting of the speech input to the at least one cloud voice recognition service. For example, the audio input device may comprise a microphone.

Another aspect is directed to a speech recognition ordering system comprising a smart speaker device configured to provide an ordering user interface, and receive speech input comprising at least one order from a given user. The speech recognition ordering system may include a first server in communication with the smart speaker device over a network and configured to generate a voice database comprising at least one biometric characteristic for each of a plurality of different users, and a voice profile for each of the plurality of different users, and receive the speech input from the smart speaker device. The first server may be configured to determine at least one given biometric characteristic for the given user and based upon the speech input, identify the given user from the plurality of different users by comparing the at least one given biometric characteristic with the at least one biometric characteristic for each of the plurality of different users, and perform speech recognition on the speech input using an order database comprising a plurality of potential order permutations, the speech recognition being based upon a given voice profile of the given user.

The speech recognition ordering system may further comprise a second server in communication with the first server via the network, and the first server may be configured to store the voice database and the order database on the second server. The second server may comprise a cloud storage service. The order database may comprise a plurality of order preferences for each of the plurality of different users, and the first server may be configured to selectively process the at least one order based upon respective order preferences of the given user.

Additionally, the smart speaker device may be configured to provide additional ordering prompts in the ordering user interface when the at least one order comprises an ambiguous order. The first server may be configured to identify the given user from the plurality of different users by verifying an identification string in the speech input. The first server may be configured to perform the speech recognition by at least transmitting the speech input to at least one cloud voice recognition service, and receiving a text speech output associated with the speech input from the at least one cloud voice recognition service. The first server may be configured to perform the speech recognition by at least load balancing the transmitting of the speech input to the at least one cloud voice recognition service.

Yet another aspect is directed to a method of speech recognition ordering. The method may include generating a voice database comprising at least one biometric characteristic for each of a plurality of different users, and a voice profile for each of the plurality of different users, providing an ordering user interface, receiving speech input comprising at least one order from a given user, and determining at least one given biometric characteristic for the given user. The method may comprise identifying the given user from the plurality of different users by comparing the at least one given biometric characteristic with the at least one biometric characteristic for each of the plurality of different users, and performing speech recognition on the speech input using an order database comprising a plurality of potential order permutations, the speech recognition being based upon a given voice profile of the given user.

### BRIEF DESCRIPTION OF THE DRAWINGS

FIG. 1 is a schematic diagram of a speech recognition ordering system, according to the present disclosure.

FIG. 2 is a flowchart of a process flow in the speech recognition ordering system of FIG. 1.

FIGS. 3A-3B are portions of a schematic diagram of another embodiment of the speech recognition ordering system, according to the present disclosure.

FIGS. 4A-4B are portions of a schematic diagram of yet another embodiment of the speech recognition ordering system, according to the present disclosure.

FIG. 5 is a schematic diagram of another embodiment of the speech recognition ordering system, according to the present disclosure.

FIG. 6 is a schematic diagram of another embodiment of the speech recognition ordering system, according to the present disclosure.

FIGS. 7 and 8 are flowcharts of a process flow in the speech recognition ordering system, according to the present disclosure.

FIG. 9 is a schematic diagram of yet another embodiment of the speech recognition ordering system, according to the present disclosure.

FIGS. 10-12 and 13A-13B are flowcharts of a process flow in the speech recognition ordering system, according to the present disclosure.

### DETAILED DESCRIPTION

The present disclosure will now be described more fully hereinafter with reference to the accompanying drawings, in which several embodiments of the invention are shown. This present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art. Like numbers refer to like elements throughout, and base 100 reference numerals are used to indicate similar elements in alternative embodiments.

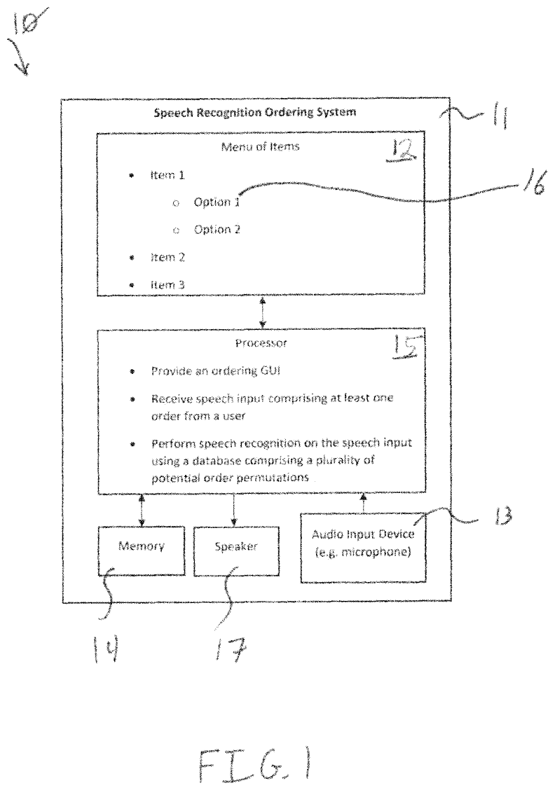

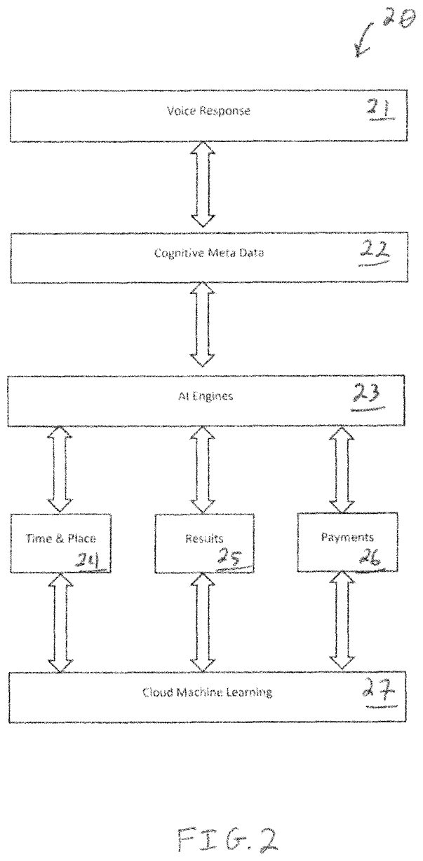

Referring initially to FIGS. 1-2, a speech recognition ordering system 10 according to the present disclosure is now described. The speech recognition ordering system 10 illustratively includes a housing 11, and a display 12 carried by the housing. For example, the display 12 may comprise a classical output only display (e.g. liquid crystal display (LCD) or organic light emitting diode (OLED) display), or a touch display, such as a capacitive touch display or resistive touch display.

As will be appreciated by those skilled in the art, the housing 11 may have a kiosk-form factor for placement in food service application, such as a fast food restaurant, or another quick service application. Indeed, the speech recognition teachings disclosed herein can be applied in many applications beyond the illustrative ordering system, such as, for example, dictation, automation voice control, voice commands smart home appliances, Internet of Things devices (IoT), and text based messaging (e.g. FaceBook messenger, short message service (SMS), Slack). In other embodiments, the speech recognition ordering system 10 may be implemented within a native software (e.g. IOS, Android) application on a mobile wireless communications device, i.e. powering a mobile ordering application.

The speech recognition ordering system 10 illustratively includes an audio input device 13 carried by the housing 11. More specifically, the audio input device 13 comprises a microphone. The speech recognition ordering system 10 illustratively includes a memory 14 (e.g. flash memory, random access memory (RAM)) carried by the housing 11, and a processor 15 carried by the housing and coupled to the display 12, audio input device 13, speaker 17, and memory.

The processor 15 is configured to provide an ordering GUI 16 on the display 12. In the illustrative example provided in FIG. 1, the ordering GUI 16 illustratively includes a plurality of items, each item comprising a plurality of sub-level options. In the example food ordering application, the sub-level options would comprise variants of the item (e.g. addition of toppings, condiments, etc.). The speech recognition ordering system 10 illustratively includes a speaker 17 also carried by the housing. In some embodiments, the display 12 may be omitted for a total speech based process.

The processor 15 is configured to receive speech input from the audio input device 13. The audio input device 13 may comprise an analog-to-digital converter (ADC) configured to generate a digital speech input from an analog speech input from the microphone. The digital speech input comprises one or more orders from a user.

The processor 15 is configured to perform speech recognition on the digital speech input using an order database comprising a plurality of potential order permutations. Depending on the application, the memory 14 is configured with an appropriate database. For example, for the food ordering application, the database is configured to include each and every menu item with each and every option permutation. Depending on the menu size, this database may include a large number of options (e.g. many thousands or more).

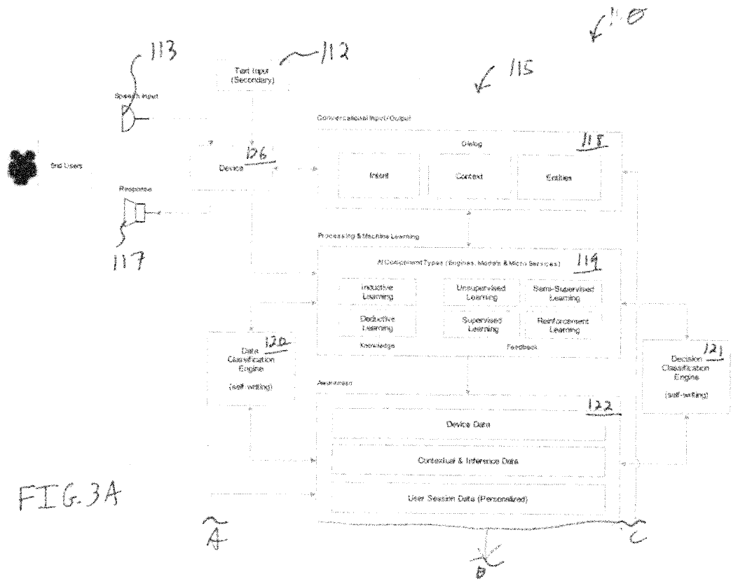

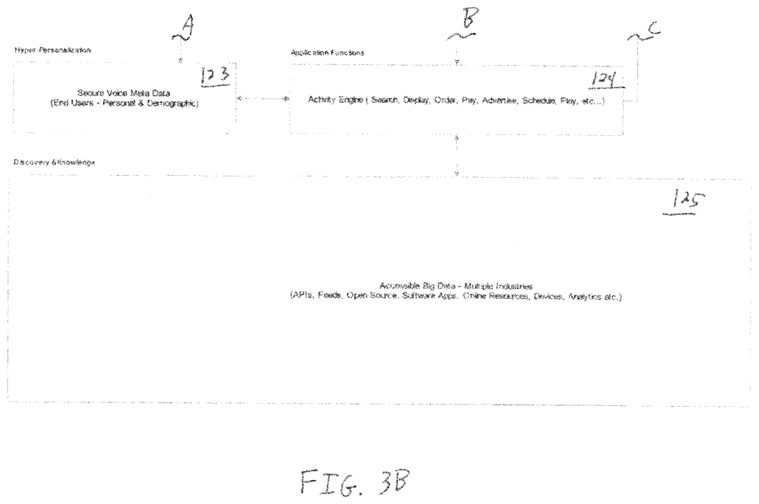

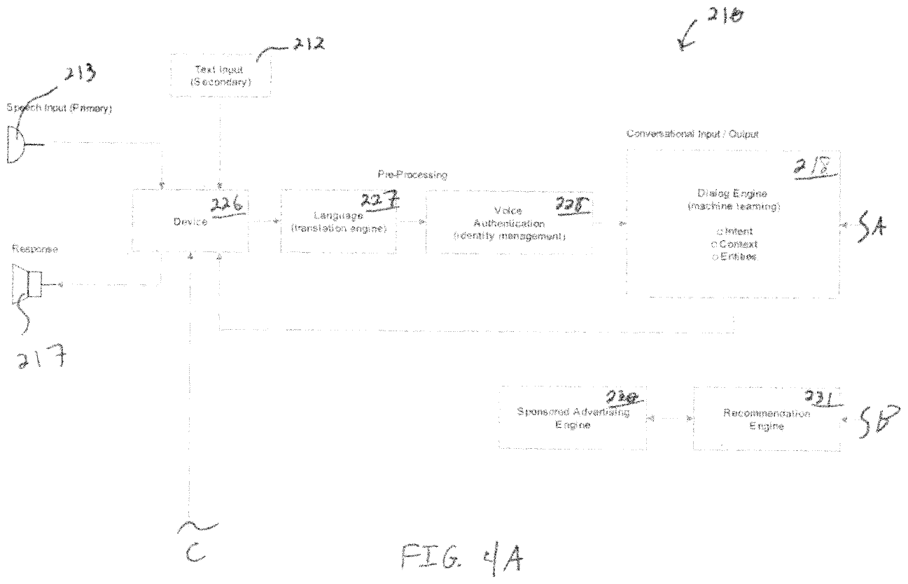

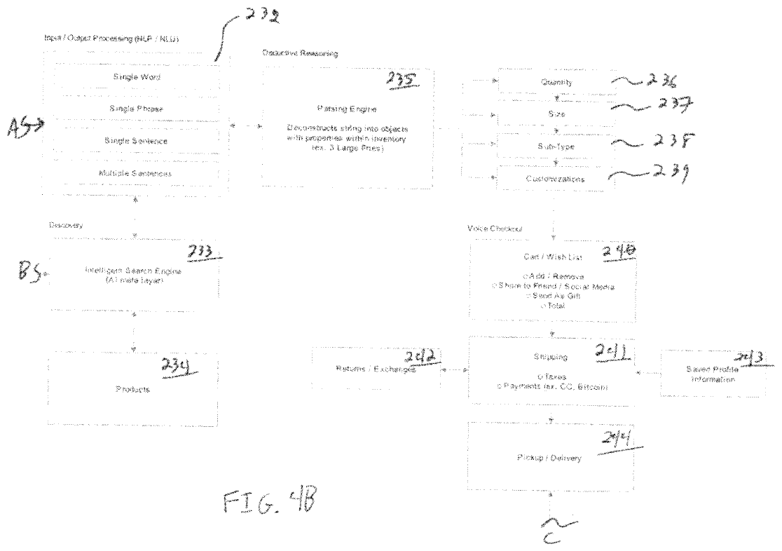

As will be appreciated, in some embodiments, the processor 15 is configured to forward the digital speech input to a cloud speech recognition provider, such as Google Cloud Speech API, as available from the Alphabet Corporation of Mountain View, Calif., or Alexa Voice Service (AVS), as available from Amazon.com, Inc. of Seattle, Wash. In this embodiment, the cloud speech recognition provider will generate a speech recognized text from the digital speech input. In other embodiments (FIGS. 3A-4B), the processor 15 is configured to perform all or at least part of the speech recognition locally.

The processor is configured to generate a database storing a plurality of characteristics for a plurality of different users. In particular, the database may store a plurality of profile data sets associated respectively with the plurality of different users. The plurality of characteristics may comprise order preferences for each user, geolocation data, demographic data for each user, and speech recognition characteristics for each user. The demographic data may comprise linguistic data, such as a native accent, and speech characteristics (e.g. annunciation patterns). In some embodiments, the processor 15 is configured to forward one or more of the characteristics to the cloud speech recognition provider to enhance speech recognition accuracy.

The processor 15 is configured to selectively process the one or more orders based upon a respective plurality of characteristics for the user. For example, the processor 15 may prompt the user with frequent ordering combinations, or order options.

In some embodiments, the speech recognition ordering system 10 includes a wireless transceiver, for example, an IEEE 802.11 transceiver, a Bluetooth transceiver, or a near field communications (NFC) transceiver, and an image sensing device. Advantageously, the speech recognition ordering system 10 may receive an identification token from a respective user.

For example, the respective user may present the identification token via an associated mobile wireless communications device. Here, for instance, the speech recognition ordering system 10 may receive the identification token from the digital wallet of the mobile wireless communications device. In some embodiments, the respective user may present a code (universal product code (UPC), quick response (QR) code) for scanning by the image sensing device of the speech recognition ordering system 10. In some embodiments, the speech recognition ordering system 10 senses persistent identification data of the mobile wireless device, such as the persistent Bluetooth identification, persistent WiFi identification (i.e. media access control (MAC) address). Positively, the speech recognition ordering system 10 is able to identify the respective user and customize the ordering GUI 16 before the user interacts with the speech recognition ordering system.

Additionally, the processor 15 is configured to provide additional ordering prompts on the ordering GUI 16 when the one or more orders comprises an ambiguous order. The prompts may be provided either visually in the ordering GUI 16, or via audio prompts from the speaker 17.

Another aspect is directed to a method for speech recognition ordering. The method includes providing an ordering GUI 16 on a display 12, receiving speech input from an audio input device 13. The speech input comprises at least one order from a user. The method also includes performing speech recognition on the speech input using an order database comprising a plurality of potential order permutations.

In FIG. 2, a diagram 20 shows top level logic flow for the speech recognition ordering system 10. The logic flow illustratively includes a voice response module 21, and a cognitive metadata module 22 downstream from the voice response module. It should be appreciated by those skilled in the art that the use of word module is exemplary. In some embodiments, the modules are purely software implemented, and in other embodiments, the modules at least partially hardware implemented, i.e. comprising circuits and associated software.

The logic flow illustratively includes an artificial intelligence (AI) engine module 23 downstream from the cognitive metadata module 22, a time and place module 24 downstream from the Al engine module, a results module 25 downstream from the AI engine module, and a payment module 26 downstream from the AI engine module. The logic flow illustratively includes a cloud machine learning module 27 downstream from the time and place module 24, the results module 25, and the payment module 26.

Referring now additionally to FIGS. 3A-3B, another embodiment of the speech recognition ordering system 110 is now described. In this embodiment of the speech recognition ordering system 110, those elements already discussed above with respect to FIGS. 1-2 are incremented by 100 and most require no further discussion herein. This embodiment differs from the previous embodiment in that this speech recognition ordering system 110 illustratively includes a text input module 112, and a device module 126 coupled to the audio input device 113 and the speaker 117.

The speech recognition ordering system 110 illustratively includes a dialog module 118 coupled to the device module 126. The dialog module 118 is the dialog engine and is configured to capture and detect conversational architecture.

The speech recognition ordering system 110 illustratively includes an AI component types module 119 coupled downstream from the dialog module 118. The AI component types module 119 is configured to store a knowledge base for deductive detection of speech.

The speech recognition ordering system 110 illustratively includes an awareness module 122 coupled downstream from the AI component types module 119. The awareness module 122 is configured to process user session data, and personalize the system based upon the user. The speech recognition ordering system 110 illustratively includes a decision classification engine module 121 and a data classification engine module 120, each being coupled between the awareness module 122 and the AI component types module 119.

The speech recognition ordering system 110 illustratively includes a secure voice metadata module 123 coupled to the awareness module 122, and an activity engine module 124 coupled to the secure voice metadata module, the awareness module, and the dialog module 118. The activity engine module 124 is configured to provide application features, search functionality, and advertising services. The speech recognition ordering system 110 illustratively includes an accessible big data module 125 coupled to the activity engine module 124.

Referring now additionally to FIGS. 4A-4B, another embodiment of the speech recognition ordering system 210 is now described. In this embodiment of the speech recognition ordering system 210, those elements already discussed above with respect to FIGS. 1-2 are incremented by 200 and most require no further discussion herein. This embodiment differs from the previous embodiment in that this speech recognition ordering system 210 illustratively includes a language and translation engine module 227 coupled downstream from the device module 226, and a voice authentication module 228 coupled downstream from the language and translation module. The voice authentication module 228 is configured to determine a voice biometric of the respective user.

The speech recognition ordering system 210 illustratively includes a sponsored advertising engine module 230, and a recommendation engine module 231 coupled to the sponsored advertising engine module. The speech recognition ordering system 210 illustratively includes an input/output processing module 232 coupled to the dialog engine 218.

The input/output processing module 232 is configured to process the digital speech input using natural language processing (NLP) and natural language understanding (NLU). In the illustrative example, the input/output processing module 232 is configured to process the digital speech input into one of a single word, a single phrase, a single sentence, and multiple sentences.

The speech recognition ordering system 210 illustratively includes an intelligent search engine module 233 coupled to the input/output processing module 232, and a products module 234 coupled to the intelligent search engine module. The speech recognition ordering system 210 illustratively includes a parsing engine module 235 coupled downstream from the input/output processing module 232. The speech recognition ordering system 210 illustratively includes quantity, size, sub-type, and customization modules 236-239, each coupled downstream from the parsing engine module 235, configured to match the recognized speech to the database of order permutations.

The speech recognition ordering system 210 illustratively includes a voice checkout module 240 coupled downstream from the quantity, size, sub-type, and customization modules 236-239. The speech recognition ordering system 210 illustratively includes a shipping module 241 coupled downstream from the voice checkout module 240, a returns/exchanges module 242 coupled to the shipping module, a profile module 243 coupled to the shipping module, and a pick-up and delivery module 244 coupled to the shipping module and the device module 226.

In the following, an exemplary discussion of an embodiment (i.e. Jetson platform) of the speech recognition ordering system 10, 110, 210 follows.

Jetson Voice Meta Layer

Creating a contextually aware, next-level AI requires a massive amount of voice data. By capturing this information through our mobile platform, Jetson platform creates a voice data meta layer (meta information) that sits on top of existing data, AI engines, models and micro services. This voice metadata is captured through a user's voice response and in turn powers voice and visual search results (e.g. Google's meta information on each web page). This metadata can be used in software and hardware applications to bring hyper-personalized conversational responses and recommendations to end users within a voice commerce platform (e.g. “Find the best burger near Times Square”→“Most people choose Shake Shack near Times Square, did you want me to order your usual?”).

Jetson Platform Voice Ordering Engine

Voice only ordering is extremely complex today, but with the Jetson platform voice commerce engine, an approach to this problem is provided. The Jetson platform understands, reasons and parses multiple (i.e. menu items with quantity, size, and type) out of a “single sentence voice response” and outputs via JavaScript Object Notation (JSON) for consumption by another service.

The Jetson platform has the ability to customize each order item via voice (e.g. “I want a Big Mac with no Lettuce”). If confused based upon pronunciation, the ability to confirm what was the via voice or touch is important. This confirmation will help drive a machine learning algorithm that will determine root cause of the misunderstanding (could be caused by accent) and recalibrate both the speech recognition engine and/or the responses within the dialog for future interactions (e.g. “Did you mean to say French Fries? Yes or No”). The Jetson platform has the ability to remove items from the checkout process via voice.

Jetson Location-Awareness Algorithm

Understanding where a user is creates a more intelligent context surrounding voice responses when ordering an item or searching for information. There are 3 different layers our algorithm must loop through, which include: First Outer Layer—Geo-fencing through the mobile device knows user's general location (e.g. Jetson platform knows I'm in Time Square) Second Middle Layer—Mobile device detection through Bluetooth beaconing based upon received signal strength indicator (RSSI) value or indoor mapping (e.g. Jetson platform knows I'm in the McDonalds at Times Square).

Third Inner Layer—Confirmation of user's location by understanding coordinates of a device through RSSI triangulation. When a user then activates the device a voice response to Jetson platform, the location can be most accurately determined (e.g. Jetson platform knows I'm at the 3rd Ordering Kiosk in the McDonalds at Times Square).

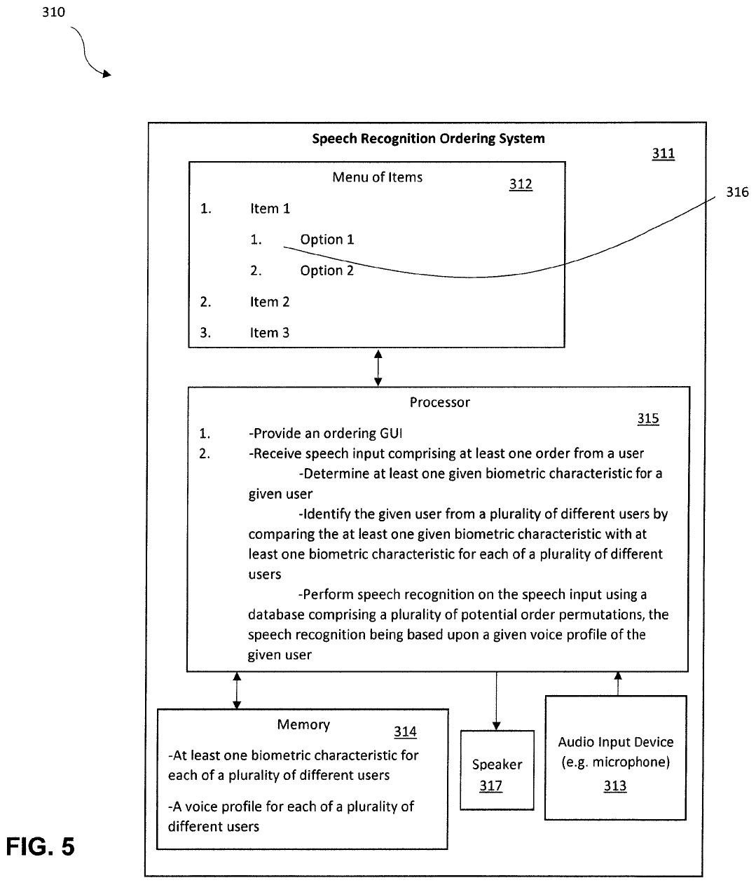

Referring now additionally to FIG. 5, another embodiment of the speech recognition ordering system 310 is now described. In this embodiment of the speech recognition ordering system 310, those elements already discussed above with respect to FIGS. 1-2 are incremented by 300 and most require no further discussion herein. This embodiment differs from the previous embodiment in that the processor 315 is illustratively configured to generate a database comprising at least one biometric characteristic for each of a plurality of different users, and a voice profile for each of the plurality of different user. The processor 315 is configured to store the database in the memory 314.

The processor 315 is configured to additionally determine at least one given biometric characteristic for the given user, and identify the given user from the plurality of different users by comparing the at least one given biometric characteristic with the at least one biometric characteristic for each of a plurality of different users. The processor 315 is configured to perform speech recognition on the speech input using a database comprising a plurality of potential order permutations, the speech recognition being based upon a given voice profile of the given user.

Also, the database includes a plurality of order preferences for each of the plurality of different users, and the processor 315 is configured to selectively process the at least one order based upon respective order preferences the given user. In other words, once the speech recognition ordering system 310 identifies the given user, the ordering GUI 316 may be selectively changed based upon past use characteristics of the given user. For example, the favorite orders of the given user may be prominently displayed for easy access and to speed up the ordering process.

Another aspect is directed to a method of speech recognition ordering. The method includes generating a database comprising at least one biometric characteristic for each of a plurality of different users, and a voice profile for each of the plurality of different users. The method also includes providing an ordering GUI 316 on a display 312, and receiving speech input from an audio input device 313, the speech input comprising at least one order from a given user. The method also includes determining at least one given biometric characteristic for the given user, identifying the given user from the plurality of different users by comparing the at least one given biometric characteristic with the at least one biometric characteristic for each of a plurality of different users, and performing speech recognition on the speech input using a database comprising a plurality of potential order permutations, the speech recognition being based upon a given voice profile of the given user

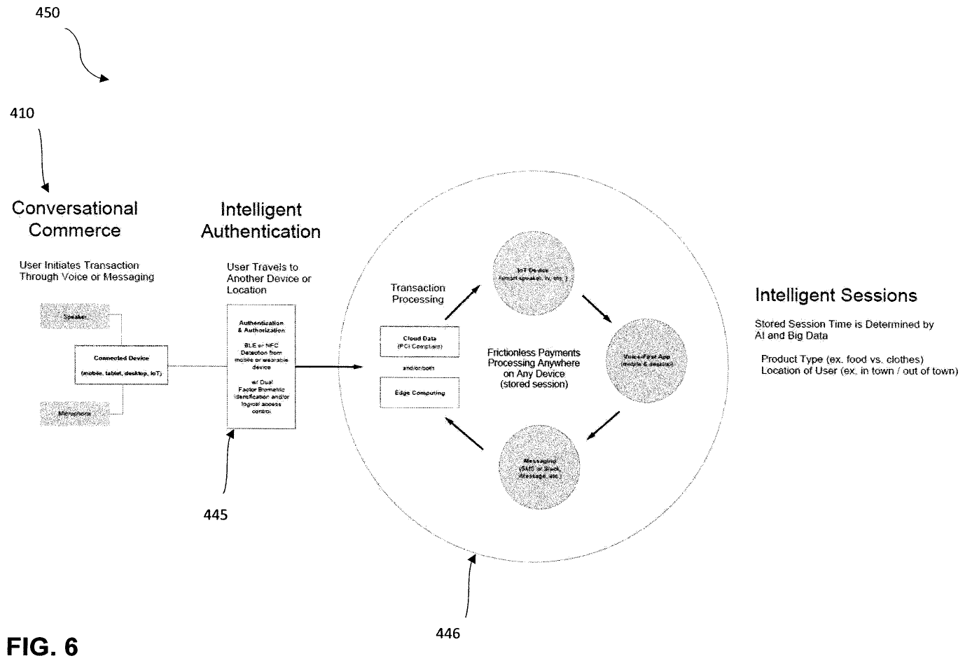

Referring now additionally to FIG. 6, another embodiment of the speech recognition ordering system 410 is now described. In this embodiment of the speech recognition ordering system 410, those elements already discussed above with respect to FIGS. 1-2 are incremented by 400 and most require no further discussion herein. This embodiment differs from the previous embodiment in that this speech recognition ordering system 410 is illustratively part of a greater voice processing system 450.

The voice processing system 450 illustratively includes an intelligent authentication module 445 in communication with the speech recognition ordering system 410. The speech recognition ordering system 410 is configured to generate a transaction via voice or messaging, which is transmitted to the intelligent authentication module 445. The intelligent authentication module 445 is configured to authenticate the transaction using dual factor biometric identification. The voice processing system 450 illustratively includes a cloud component 446 configured to process the transaction. The cloud component 446 comprises a cloud data component, an Internet of things (IoT) component coupled downstream from the cloud data component (e.g. Payment Card Industry (PCI) compliant secure store of data), a voice first application component coupled downstream from the IoT component, a messaging component coupled downstream from the voice first application component, and an edge computing component coupled downstream from the messaging component.

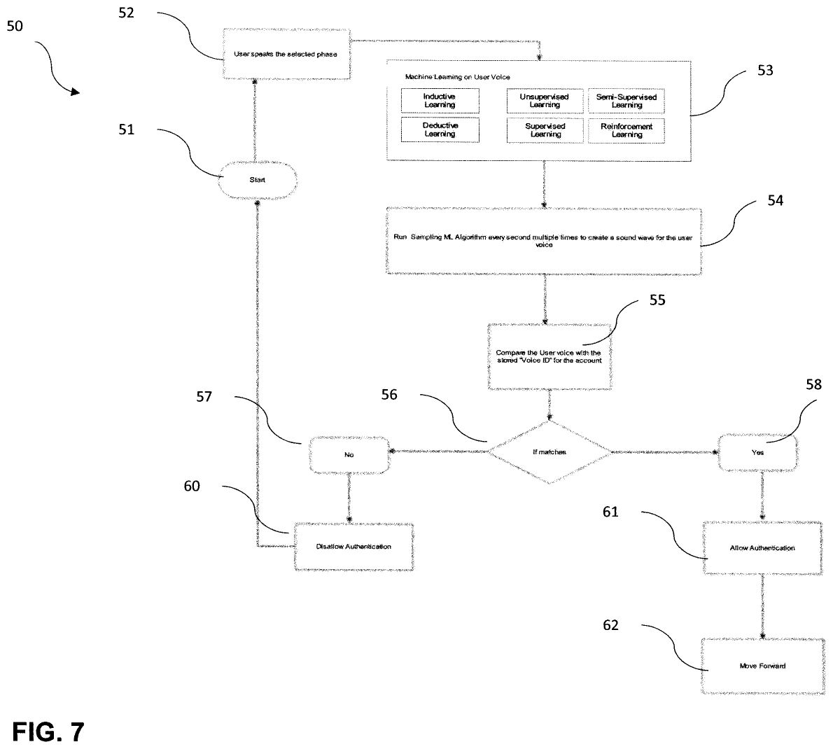

Referring to FIG. 7, a flowchart 50 illustrates a method for authenticating a voice input in the voice processing system 450. The method illustratively includes a user speaking a selected phrase, i.e. the voice input, and a voice processing step enhanced with machine learning. (Blocks 51, 52). The method includes a sampling step where the voice input is sampled, and a comparison step where the at least one given biometric characteristic from the voice input is compared with the at least one biometric characteristic for each of a plurality of different users for authentication. (Blocks 53-58, 60-62).

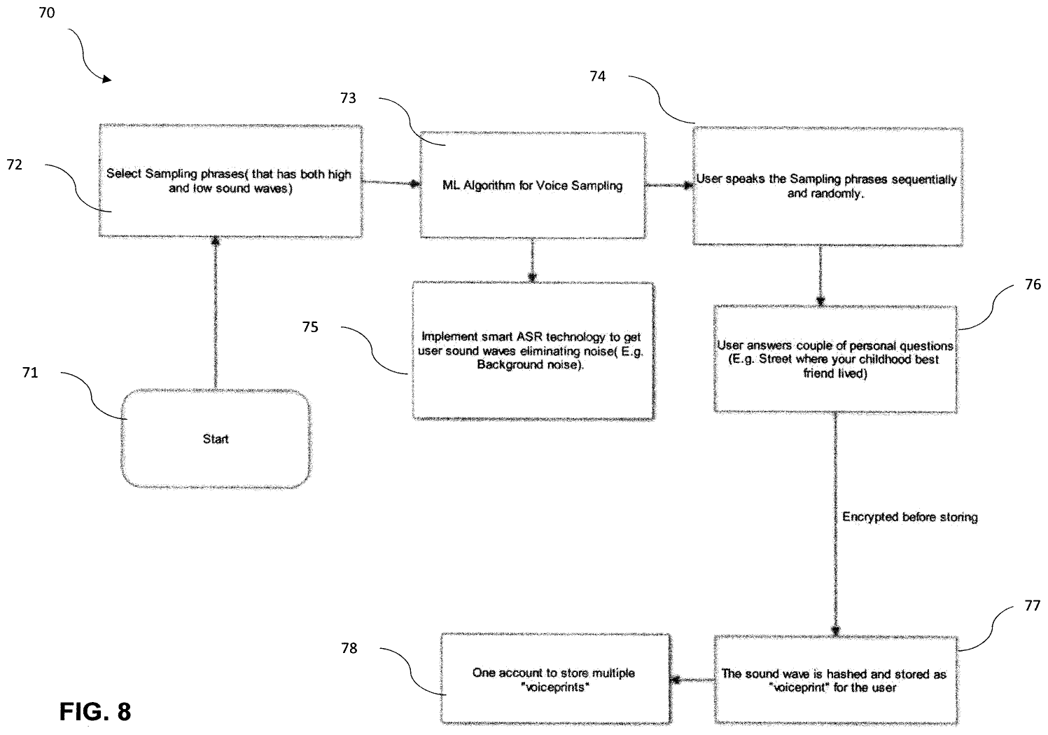

Referring to FIG. 8, a flowchart 70 illustrates a method for sampling a voice input in the operation the voice processing system 450. (Blocks 71, 72). In other words, the process for generating a voice print of the user. The method illustratively includes selecting a sampling phase. The sampling phrase is a set text phrase for the user to speak that generates enough voice data to provide the voice print.

The method illustratively includes executing a machine learning algorithm for voice sampling. (Blocks 73, 74). The machine learning algorithm illustratively includes a supervised learning module, an unsupervised learning module, an inductive learning module, a deductive learning module, a semi-supervised learning module, and a reinforcement learning module. Of course, in other embodiments, one or more of these learning modules may be omitted.

The method includes executing automated speech recognition (ASR) to generate user sound data without noise. (Blocks 75). For example, background noise may be blocked. The method includes the user answering a couple of personal questions, and hashing the voiceprint of the user for storage. (Blocks 76-78).

In the following, another exemplary discussion of the speech recognition ordering system 10, 210, 310, 410 follows.

What is Voice Authentication?

The technology where user's voice is used to authenticate the transactions. Because of its relative permanence of the characteristics it measures, the technology is not likely to be fooled by an attempt to disguise the voice.

The Biometric Voice Authentication (Voice ID) should not be changed by slight change in voice, such as a bad cold or an extreme emotion. Voice ID is not binary (yes or no decision), so it requires statistical analysis and sampling technologies to match with the original end user.

How to Achieve Voice Authentication?

In order to achieve the Voice ID, the speech recognition ordering system will ask user to repeat a list of words, which also needs to be repeated in random combinations. So every time, user's voice will be compared with prerecorded “voiceprint” sample of their speech. The speech recognition ordering system will build an algorithm used for voice sampling in order to distinguish the speech for the user.

Sampling is a method to measure voltage of the signal at regular intervals, many times per second. Using machine learning to create a voice template for every user, which is then used to compare the sampling frequency of user voice and give the matching percentage. A threshold matching percentage is than used in order to authenticate the user's voice as a “voiceprint”.

Security Concern with Voice Authentication

Having a database full of voice recordings also increase the risk of security breaches. The speech recognition ordering system has to be on top of security and privacy policies in order to have voice authentication work seamlessly. A possible approach to this is to store the voice samples encrypted with cryptographic algorithm and decrypt it over the runtime using the private and public key combination.

Voice Profiling with Jetson

Distinguishing Voice for the Voice ID

The sampling method is used to compare the user voice with the one stored as “voiceprint”. The speech recognition ordering system is to compare the sampling frequency in order to authenticate the payment, separating the child voice with an adult voice.

How to Achieve Voice Profiling?

Using machine learning to allow multiple voices to use the speech recognition ordering system for one account. For example, the Google Assistant currently can recognize 6 voices. The backend to do this involves writing deep learning algorithm which uses the training data from large audio scripts or YouTube audios to differentiate between the sound frequency and voices. Once the raw labeled data is available, the system can do convolutional neural network (CNN) training on the voice data using a feature method.

A feature vector is created and it is fed into a support vector machine (SVM) or random forest classification model. The result would be accuracy of trained model over the test data received. The model can be improved further if required by using the voice samples collected through Jetson's conversational model.

Challenges to Achieve Voice Profiling.

The challenge to train the model with voice profiling is the lack of open source speech data. Most of the data is proprietary, not accurate or insufficiently labeled. Research shows that LibriVox can be the solution for this as it has large source of open audio books. For scrapping the voice data from LibriVox or YouTube, the Selenium software suite can be used for automating the process. The accuracy of the trained neural network model needs to be between 94-97%.

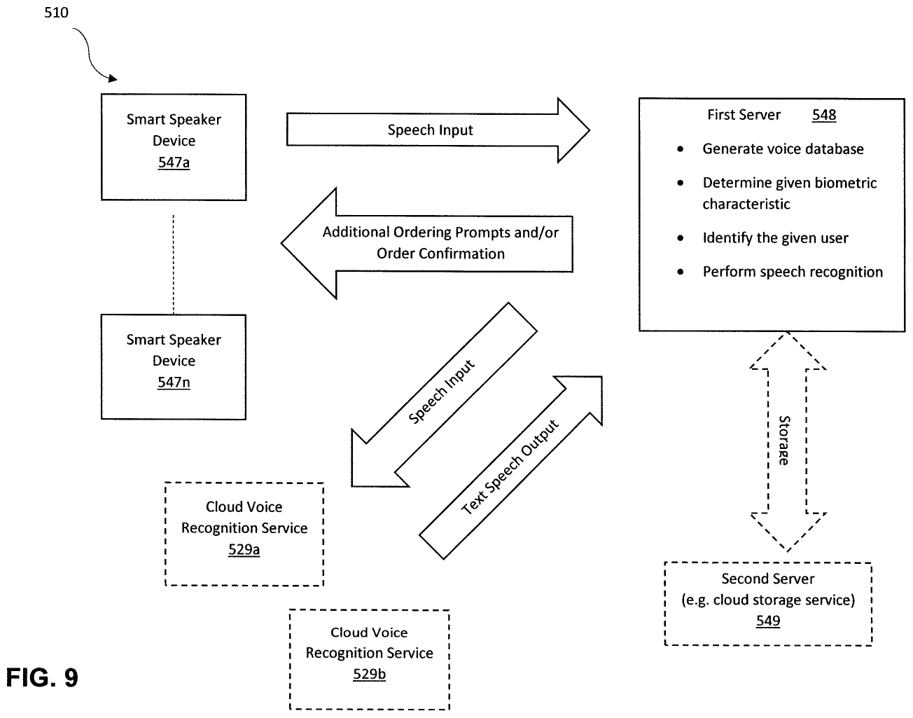

Referring now additionally to FIG. 9, another embodiment of the speech recognition ordering system 510 is now described. In this embodiment of the speech recognition ordering system 510, those elements already discussed above with respect to FIGS. 1-2 and 5 are incremented by 500 and most require no further discussion herein. This embodiment differs from the previous embodiment in that the speech recognition ordering system 510 illustratively comprises a plurality of smart speaker devices 547a-547n. Each of the plurality of smart speaker devices 547a-547n is configured to provide an ordering user interface. A given smart speaker device 547a from the plurality thereof is configured to receive speech input comprising at least one order from a given user. As will be appreciated, the plurality of smart speaker devices 547a-547n may be geographical spaced apart at different vendor/customer locations.

The speech recognition ordering system 510 illustratively includes a first server 548 in communication with the plurality of smart speaker devices 547a-547n over a network (e.g. the Internet or a closed internal network) and configured to generate a voice database comprising at least one biometric characteristic for each of a plurality of different users, and a voice profile for each of the plurality of different users. The first server 548 is configured to receive the speech input from the given smart speaker device 547a. The first server 548 is configured to determine at least one given biometric characteristic for the given user and based upon the speech input, identify the given user from the plurality of different users by comparing the at least one given biometric characteristic with the at least one biometric characteristic for each of the plurality of different users, and perform speech recognition on the speech input using an order database comprising a plurality of potential order permutations, the speech recognition being based upon a given voice profile of the given user.

In some embodiments, the speech recognition ordering system 510 illustratively comprises a second server 549 in communication with the first server 548 via the network. The first server 548 may be configured to store the voice database and the order database on the second server 549. For example, the second server 549 may comprise a cloud storage service, or a customer selected storage. In the illustrated embodiment, the second server 549 is indicated with dashed lines. In other embodiments, the second server can be omitted and the first server 548 may host the storage in an integrated fashion.

The order database may comprise a plurality of order preferences for each of the plurality of different users, and the first server 548 is configured to selectively process the at least one order based upon respective order preferences of the given user. Additionally, the given smart speaker device 547a is configured to provide additional ordering prompts in the ordering user interface when the at least one order comprises an ambiguous order.

The first server 548 is configured to identify the given user from the plurality of different users by verifying an identification string in the speech input. For example, the identification string may comprise a personal identification number (PIN), or a user telephone number. The first server 548 is configured to compare the received identification string with a plurality of stored strings and associated users.

In some embodiments, the first server 548 is configured to perform the speech recognition by at least transmitting the speech input to a plurality of cloud voice recognition services 529a-529b. As will be appreciated, the plurality of cloud voice recognition services 529a-529b may comprise one or more of the Google Cloud Speech API, and the Alexa Voice Service (AVS). The first server 548 is configured to receive a text speech output associated with the speech input from the plurality of cloud voice recognition services 529a-529b.

Also, the first server 548 may be configured to perform the speech recognition by at least load balancing the transmitting of the speech input to the plurality of cloud voice recognition services 529a-529b. In particular, the first server 548 may divide the speech recognition requests between the plurality of cloud voice recognition services 529a-529b based upon a customer preference. For example, a given vendor/customer may wish to avoid the Google Cloud Platform for competitive reasons.

Yet another aspect is directed to a method of speech recognition ordering. The method includes generating a voice database comprising at least one biometric characteristic for each of a plurality of different users, and a voice profile for each of the plurality of different users, providing an ordering user interface, receiving speech input comprising at least one order from a given user, and determining at least one given biometric characteristic for the given user. The method comprises identifying the given user from the plurality of different users by comparing the at least one given biometric characteristic with the at least one biometric characteristic for each of the plurality of different users, and performing speech recognition on the speech input using an order database comprising a plurality of potential order permutations, the speech recognition being based upon a given voice profile of the given user.

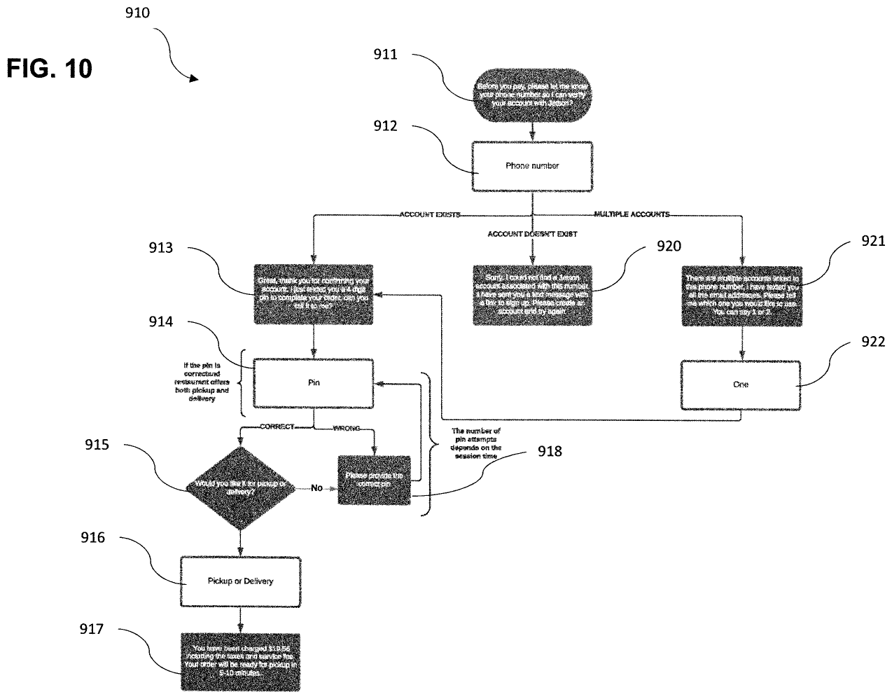

Referring now additionally to FIG. 10, a diagram 910 shows a process flow for the given user to place an order using the given smart speaker device 547a. Since the given smart speaker device 547a relies solely on voice input and output to interact with the user, the first server 548 is configured to identify and verify the identity of the given user solely via voice input and output of the given smart speaker device 547a. In Blocks 911-914 & 918, the given user is correlated to a user account via the phone number, and then an authentication text message is sent to the mobile device associated with the telephone number to verify the given user (i.e. providing multi-factor authentication). This authentication is either used in addition or in alternative to the at least one given biometric characteristic from the speech input.

Once the given user has been attached to an existing account, the order is taken in Blocks 915-917. If the provided telephone number has multiple accounts associated with it, Blocks 921-922 permit the given user to select the appropriate account. If the telephone number does not exist in the order database, the process ends with Block 920.

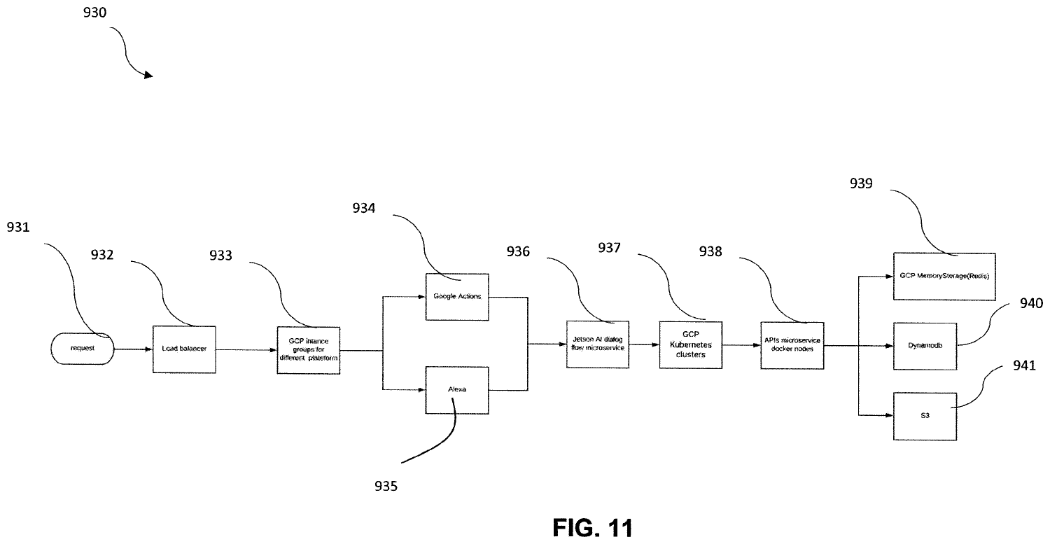

Referring now additionally to FIG. 11, a diagram 930 shows a process flow for the first server 548 interacting with the plurality of cloud voice recognition services 529a-529b and the second server 549. As will be appreciated, the first server 548 is interacting with the plurality of smart speaker devices 547a-547n. Within the plurality of smart speaker devices 547a-547n, there are a plurality of sets, each set being associated with a respective vendor/customer. So, as requests come into the first server 548, the first server must first organize the requests based upon the originating set and vendor/customer. (Blocks 931-932). For example, each vendor/customer may be associated with a cloud platform instance (e.g. Google Cloud Platform (GCP) Instance). (Block 933).

Depending on the preferences of each vendor/customer, the voice recognition request will be sent to either of the plurality of cloud voice recognition services 529a-529b. (Blocks 934-935). Blocks 936-941 relate to the storage of the voice and order data to the second server 549.

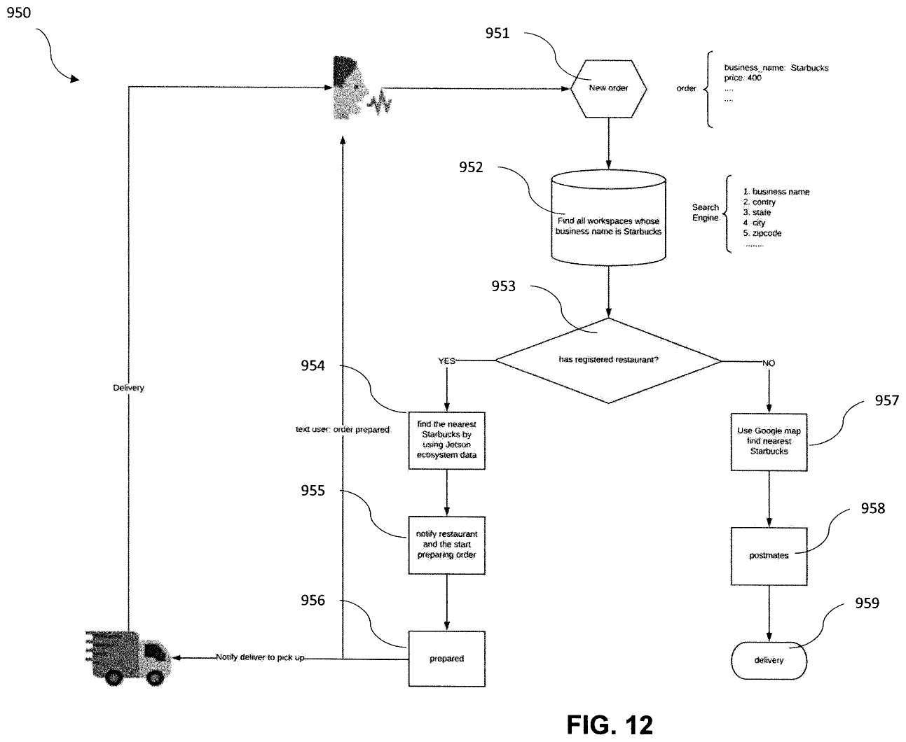

Referring now additionally to FIG. 12, a diagram 950 shows a process flow for the first server 548 interacting with the given user via the given smart speaker device 547a to determine the specific order and associated vendor. At Blocks 951-952, the order is received and the first server 548 finds the associated workspace with the requested business name. If the business is not registered with the first server 548, the first server interacts with an external food delivery service (e.g. the illustrated Postmates) and uses location data from the given user to place the order. (Blocks 953, 957-959). If the business is registered, the first server 548 internally forwards the order to the nearest vendor/customer location and notifies the delivery service. (Blocks 953-956).

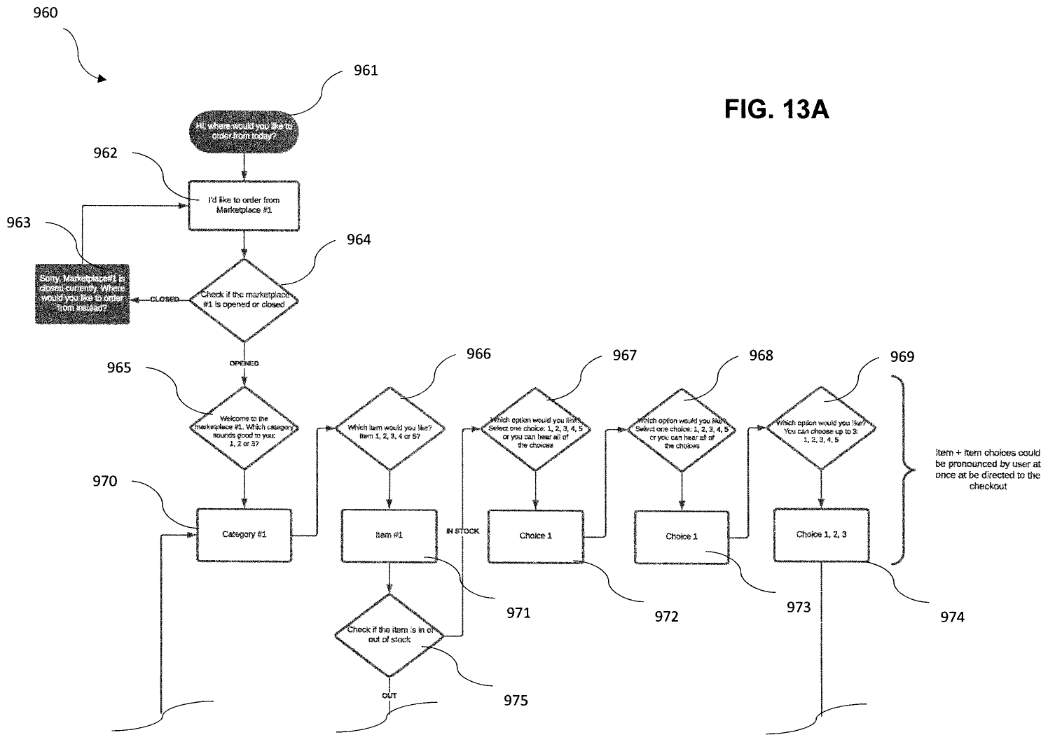

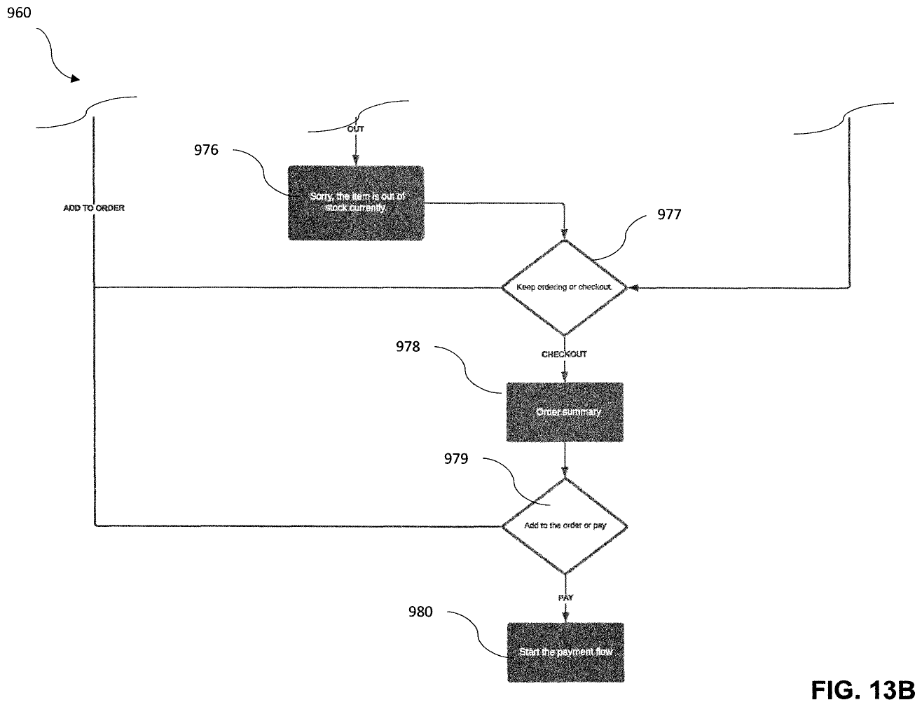

Referring now additionally to FIGS. 13A-13B, a diagram 960 shows a process flow for the first server 548 interacting with the given user via the given smart speaker device 547a to determine the specific order and associated vendor. Blocks 961-964 relate to the given user determining which marketplace (i.e. vendor/customer) is selected. Blocks 965-977 walk the user through selecting the product and options. Blocks 978-980 relate to the payment flow after the order is finalized for the given user.

It should be appreciated that features from each of the embodiments of the speech recognition ordering system 10, 110, 210, 310, 410, 510 detailed hereinabove may be combined. Many modifications and other embodiments of the present disclosure will come to the mind of one skilled in the art having the benefit of the teachings presented in the foregoing descriptions and the associated drawings. Therefore, it is understood that the present disclosure is not to be limited to the specific embodiments disclosed, and that modifications and embodiments are intended to be included within the scope of the appended claims.

That which is claimed is:

1. A speech recognition ordering system comprising:
a housing;
a display carried by said housing;
an audio input device carried by said housing;
a memory carried by said housing; and
a processor carried by said housing and coupled to said display, audio input device, and memory, said processor configured to
generate a voice database comprising at least one biometric characteristic for each of a plurality of different users, and a voice profile for each of the plurality of different users,
provide an ordering graphical user interface (GUI) on said display,
receive speech input from said audio input device, the speech input comprising at least one order from a given user,
determine at least one given biometric characteristic for the given user and based upon the speech input,
identify the given user from the plurality of different users by comparing the at least one given biometric characteristic with the at least one biometric characteristic for each of the plurality of different users, and
perform speech recognition on the speech input using an order database comprising a plurality of potential order permutations, the speech recognition being based upon a given voice profile of the given user.

2. The speech recognition ordering system of claim 1 wherein the order database comprises a plurality of order preferences for each of the plurality of different users; and wherein said processor is configured to selectively process the at least one order based upon respective order preferences of the given user.

3. The speech recognition ordering system of claim 1 wherein said processor is configured to provide additional ordering prompts on the GUI when the at least one order comprises an ambiguous order.

4. The speech recognition ordering system of claim 1 wherein said processor is configured to identify the given user from the plurality of different users by verifying an identification string in the speech input.

5. The speech recognition ordering system of claim 1 wherein said processor is configured to perform the speech recognition by at least transmitting the speech input to at least one cloud voice recognition service, and receiving a text speech output associated with the speech input from the at least one cloud voice recognition service.

6. The speech recognition ordering system of claim 5 wherein said processor is configured to perform the speech recognition by at least load balancing the transmitting of the speech input to the at least one cloud voice recognition service.

7. The speech recognition ordering system of claim 1 wherein said audio input device comprises a microphone.

8. A speech recognition ordering system comprising:
a smart speaker device configured to
provide an ordering user interface, and
receive speech input comprising at least one order from a given user; and
a first server in communication with said smart speaker device over a network and configured to
generate a voice database comprising at least one biometric characteristic for each of a plurality of different users, and a voice profile for each of the plurality of different users,
receive the speech input from said smart speaker device,
determine at least one given biometric characteristic for the given user and based upon the speech input,
identify the given user from the plurality of different users by comparing the at least one given biometric characteristic with the at least one biometric characteristic for each of the plurality of different users, and
perform speech recognition on the speech input using an order database comprising a plurality of potential order permutations, the speech recognition being based upon a given voice profile of the given user.

9. The speech recognition ordering system of claim 8 further comprising a second server in communication with said first server via the network; and wherein said first server is configured to store the voice database and the order database on said second server.

10. The speech recognition ordering system of claim 9 wherein said second server comprises a cloud storage service.

11. The speech recognition ordering system of claim 8 wherein the order database comprises a plurality of order preferences for each of the plurality of different users; and wherein said first server is configured to selectively process the at least one order based upon respective order preferences of the given user.

12. The speech recognition ordering system of claim 8 wherein said smart speaker device is configured to provide additional ordering prompts in the ordering user interface when the at least one order comprises an ambiguous order.

13. The speech recognition ordering system of claim 8 wherein said first server is configured to identify the given user from the plurality of different users by verifying an identification string in the speech input.

14. The speech recognition ordering system of claim 8 wherein said first server is configured to perform the speech recognition by at least transmitting the speech input to at least one cloud voice recognition service, and receiving a text speech output associated with the speech input from the at least one cloud voice recognition service.

15. The speech recognition ordering system of claim 14 wherein said first server is configured to perform the speech recognition by at least load balancing the transmitting of the speech input to the at least one cloud voice recognition service.

16. A method of speech recognition ordering comprising:
generating a voice database comprising at least one biometric characteristic for each of a plurality of different users, and a voice profile for each of the plurality of different users;
providing an ordering user interface;
receiving speech input comprising at least one order from a given user;
determining at least one given biometric characteristic for the given user;
identifying the given user from the plurality of different users by comparing the at least one given biometric characteristic with the at least one biometric characteristic for each of the plurality of different users; and
performing speech recognition on the speech input using an order database comprising a plurality of potential order permutations, the speech recognition being based upon a given voice profile of the given user.

17. The method of claim 16 wherein the order database comprises a plurality of order preferences for each of the plurality of different users; and further comprising selectively processing the at least one order based upon respective order preferences of the given user.

18. The method of claim 16 further comprising providing additional ordering prompts on the ordering user interface when the at least one order comprises an ambiguous order.

19. The method of claim 16 further comprising identifying the given user from the plurality of different users by verifying an identification string in the speech input.

20. The method of claim 16 wherein the speech recognition is performed by at least transmitting the speech input to at least one cloud voice recognition service, and receiving a text speech output associated with the speech input from the at least one cloud voice recognition service.
